(19) United States
(12) Patent Application Publication
(10) Pub. No.: US 2025/0222762 A1
(43) Pub. Date: Jul. 10, 2025

(54) DRIVING MODULE AND MOBILE ROBOT INCLUDING THE SAME

(71) Applicant: HL MANDO CORPORATION, Gyeonggi-so (KR)

(72) Inventors: Min Hye YU, Gyeonggi-do (KR); Seong Ho CHOI, Gyeonggi-do (KR); Joon-Kyu SONG, Gyeonggi-do (KR); Jeong Jae PARK, Gyeonggi-do (KR); Junha SOHN, Gyeonggi-do (KR); Dongseon KIM, Gyeonggi-do (KR); Oseok KWON, Gyeonggi-do (KR); Mingeun PARK, Gyeonggi-do (KR); Byungyong KANG, Gyeonggi-do (KR)

(21) Appl. No.: 18/829,287

(22) Filed: Sep. 10, 2024

(30) Foreign Application Priority Data
Jan. 5, 2024 (KR) 10-2024-0001969

(51) Int. Cl. B60K 17/342; B60K 7/00; B60K 17/04; B60K 17/356; B62D 37/00; F16H 7/02

(52) U.S. Cl. CPC B60K 17/342; B60K 7/0007; B60K 17/043; B60K 17/356; B62D 37/00; F16H 7/02; B60K 2007/0061

(57) ABSTRACT

A driving module and a mobile robot comprising the same are disclosed. The driving module according to one aspect of the present disclosure includes: a frame supporting a robot body; and a pair of wheel units respectively coupled to left and right areas of the frame to tilt in front and rear directions about a virtual axis line extending in left and right directions, wherein each of the pair of wheel units include: a base member rotatably coupled to the frame about the virtual axis line; a front-wheel rotatably coupled to the front portion of the base member based on the virtual axis line about an axis line parallel to the virtual axis line; a rear-wheel rotatably coupled to the rear portion of the base member based on the virtual axis line about an axis line parallel to the virtual axis line; and a driving unit providing a rotational driving force to at least one of the front-wheel and the rear-wheel.

### CROSS-REFERENCE TO RELATED APPLICATION

This application claims priority to and the benefit of Korean Patent Application No. 10-2024-0001969, filed on Jan. 5, 2024, the disclosure of which is incorporated herein by reference in its entirety.

### FIELD

The present disclosure relates to a driving module and a mobile robot including the same.

### BACKGROUND

As robot technology develops, robots are used in various fields. In particular, research has been actively conducted on robots that autonomously move by recognizing objects around them according to user commands. For example, robots that serve food and beverages on a designated table when a table number is input, and robots that deliver towels to a designated room in accommodation facilities such as hotels are being developed.

Mobile robots should be able to travel in a variety of routes, especially in various terrains. The mobile robots need to travel not only on flat ground but also along sometimes bumpy road surfaces.

In order for the mobile robots to move along various road surfaces with a sense of balance, grip force with the road surface is important.

Technology development to improve the grip of the mobile robots is in progress. Conventionally, there was a case of applying a suspension structure such as a car to the mobile robots, but there was a problem of increasing cost.

### SUMMARY

### Technical Problem

The present disclosure is for solving the problems as above, and it is an object of the present disclosure to provide a driving module configured to improve a grip force and a mobile robot including the same.

The technical problems of the present disclosure are not limited to the above-mentioned technical problems, and other technical problems not mentioned may be clearly understood by those skilled in the art to which the present disclosure pertains from the following description.

The objects of the present disclosure are not limited to the above-described objects, and other objects that are not mentioned can be clearly understood by those skilled in the art to which the present disclosure pertains from the following description.

### Technical Solution

According to an aspect of the present disclosure, a driving module may be provided, including: a frame supporting a robot body; and a pair of wheel units respectively coupled to left and right areas of the frame to tilt in front and rear directions about a virtual axis line extending in left and right directions, wherein each of the pair of wheel units comprise: a base member rotatably coupled to the frame about the virtual axis line; a front-wheel rotatably coupled to the front portion of the base member based on the virtual axis line about an axis line parallel to the virtual axis line; a rear-wheel rotatably coupled to the rear portion of the base member based on the virtual axis line about an axis line parallel to the virtual axis line; and a driving unit providing a rotational driving force to at least one of the front-wheel and the rear-wheel.

In this case, the frame may include a first support unit to which the pair of wheel units is rotatably coupled about the virtual axis line; and a second support unit supporting the robot body with respect to the first support unit.

In this case, the first support unit may include a rotating shaft disposed on the virtual axis line and to which the pair of wheel units are rotatably coupled.

In this case, the rotating shaft may be provided as a single member extending in the left and right directions.

Meanwhile, a pair of rotating shafts may be provided, the pair of rotating shafts are disposed to be spaced apart from each other in left and right directions, the pair of wheel units are rotatably coupled to the pair of rotating shafts, and wherein the first support unit may further include a coupling support member that couples the pair of rotating shafts in an aligned state on the virtual axis line.

Meanwhile, the second support unit may include: a support member extending up and down and supported by the first support unit; and a ball joint interposed between the support member and the robot body and providing a degree of freedom of rotation between the support member and the robot body, and coupling the support member and the robot body.

In this case, the ball joint may include: a ball formed at an upper end of the support member; and a socket having an accommodating groove for receiving the ball, and coupled to the robot body.

In this case, an inclined surface may be formed on the entrance side of the accommodating groove.

Meanwhile, the second support unit may include: a support member supported on the first support unit and extending up and down; and a thrust bearing interposed between the support member and the robot body and providing a degree of freedom of rotation between the support member and the robot body and coupling the support member and the robot body.

Meanwhile, the driving module may further include: a pair of restoring force providing unit providing a restoring force to restore each of the pair of wheel units to its original state before the tilting operation when each of the pair of wheel units tilts with respect to the frame about the virtual axis line.

In this case, the frame may include a rotating shaft to which the pair of wheels are rotatably coupled about the virtual axis line, and wherein each of the pair of restoring force providing units may include: a first plate coupled to the rotating shaft and extending radially from the rotating shaft; a second plate coupled to the base member to be spaced apart from the first plate to face the first plate; and a resilient body interposed between the first plate and the second plate and providing an elastic force to restore the first plate to its original state before a gap change when there is the gap change between the first plate and the second plate.

Meanwhile, the frame may include a rotating shaft to which the pair of wheels are rotatably coupled about the virtual axis line, and wherein each of the pair of restoring force providing units each may include: a hub structure comprising a hub having a hollow shape and coupled to the rotating shaft, and a first plate having one end coupled to the hub and extending radially from the hub; a second plate coupled to the base member to be spaced apart from the first plate while facing the first plate; and a resilient body interposed between the first plate and the second plate and providing an elastic force to restore the first plate to its original state before a gap change when there is the gap change between the first plate and the second plate.

Meanwhile, the driving unit may include: a driving motor supported on the base member; and a power transmission unit that transmits the rotational driving force generated by the driving motor to at least one of the front-wheel and the rear-wheel.

In this case, the power transmission unit may include: a driving pulley coupled to the driving motor and rotating about an axis line parallel to the virtual axis line; a driven pulley having the same axis line as a selected wheel among the front-wheel and the rear-wheel, and rotatably supported on the base member; a main belt that connects the driving pulley and the driven pulley to transmit power; a first pulley having the same axis as the selected wheel and the driven pulley, and rotatably supported on the base member; a second pulley having the same axis as an unselected wheel among the front-wheel and the rear-wheel, and rotatably supported on the base member; and a sub-belt that connects the first pulley and the second pulley to transmit power, wherein the selected wheel, the driven pulley, and the first pulley are coupled to the rotating shaft of the selected wheel, which is rotatably supported on the base member, and the unselected wheel and the second pulley are coupled to the rotating shaft of the unselected wheel, which is rotatably supported on the base member.

In this case, the driving pulley, the driven pulley, the main belt, the first pulley, the second pulley, and the sub-belt may be provided in the form of a timing belt pulley.

Meanwhile, the driving pulley, the driven pulley, the main belt, the first pulley, the second pulley, and the sub-belt may be disposed on a side where the front-wheel and the rear-wheel are located about the base member.

In this case, the driving pulley, the driven pulley, the main belt, the first pulley, the second pulley, and the sub-belt may be covered by a housing coupled to the base member.

Meanwhile, the driving pulley, the driven pulley, the main belt, the first pulley, the second pulley, and the sub belt may be disposed on an opposite side of the side where the front-wheel and the rear-wheel are located about the base member.

According to another aspect of the present disclosure, a mobile robot may be provided, including the driving module; and the robot body supported on the frame of the driving module.

### Advantageous Effects

According to one aspect of the present disclosure, the wheel unit performs a tilting operation with respect to the rotating shaft of frame about a virtual axis line depending on road surface conditions, so that the drive module is not restricted by the road surface conditions and can be traveling with a sense of balance by being supported at four points on the road surface, that is, by the two front-wheels and two rear-wheels included in the pair of wheel units.

Furthermore, the restoring force providing unit restores the wheel unit to its original state before the tilting operation when the wheel unit performs the tilting operation with respect to the rotating shaft of frame about the virtual axis line, so that the impact due to the tilting operation can be alleviated with elasticity, and the wheel unit can be easily restored to its original tilting state, making it easy to maintain the balance of the driving module.

It should be understood that the effects of the present disclosure are not limited to the above-described effects, and include all effects that can be inferred from the construction of the invention described in the detailed description or claims.

### BRIEF DESCRIPTION OF THE DRAWINGS

The above and other objects, features and advantages of the present disclosure are more apparent to those of the art by describing exemplary embodiments thereof in detail with reference to the accompanying drawings:

FIG. 1 is a perspective view of a mobile robot according to an embodiment of the present disclosure, viewed from one direction.

FIG. 2 is a perspective view of a driving module according to an embodiment of the present disclosure, viewed from one direction.

FIG. 3 is a perspective view of a driving module according to an embodiment of the present disclosure, viewed from another direction.

FIG. 4 is a plan view of a driving module according to an embodiment of the present disclosure, viewed from above.

FIG. 5 is a side view of a driving module according to an embodiment of the present disclosure.

FIG. 6 is a view illustrating a modified example of the first support unit shown in FIG. 2.

FIG. 7 is a cross-sectional view taken along A-A of FIG. 4.

FIG. 8 is a view illustrating a modified example of the second support unit shown in FIG. 7.

FIG. 9 is a view illustrating a modified example of the arrangement of the power transmission unit shown in FIG. 4.

FIG. 10 is an enlarged view of the restoring force providing unit according to an embodiment of the present disclosure.

FIG. 11 is a view illustrating a modified example of the restoring force providing unit shown in FIG. 10.

FIG. 12 is a view illustrating a state in which the mobile robot travels a bumpy road surface according to an embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used In the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

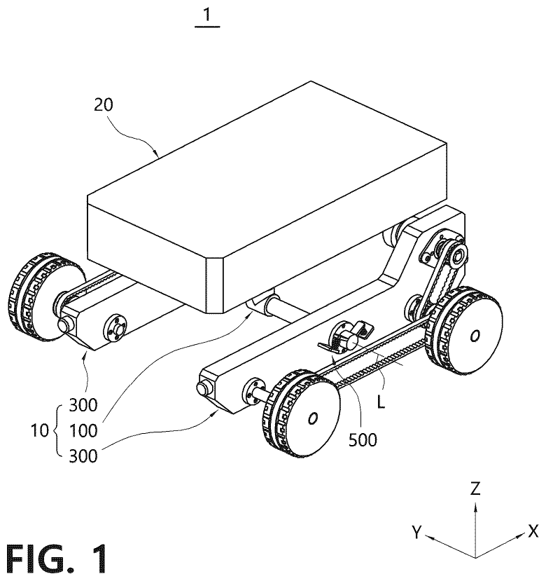

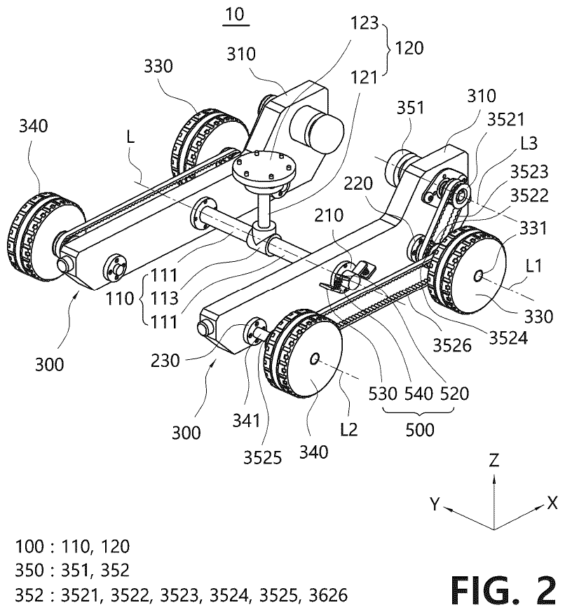

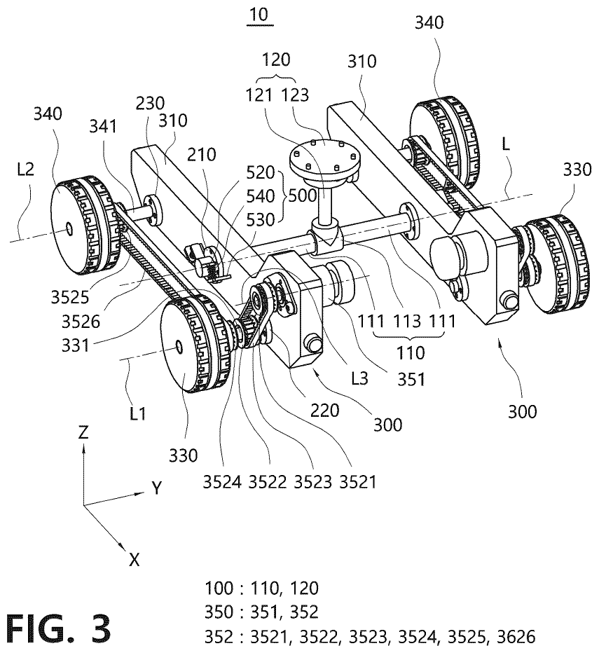

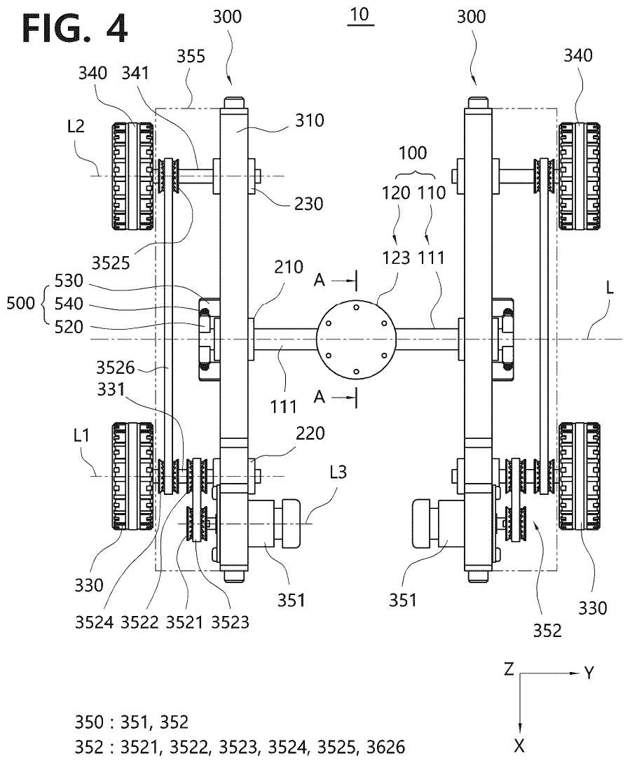

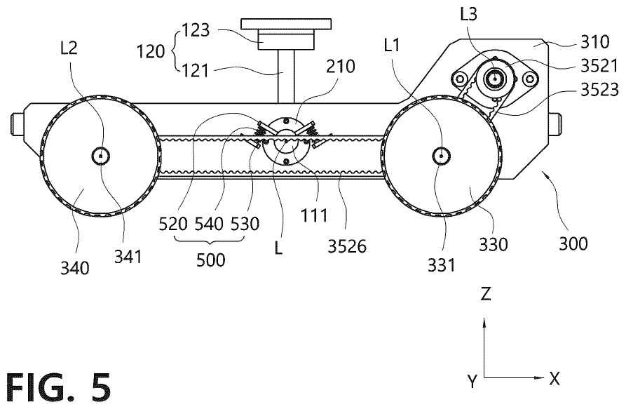

FIG. 1 is a perspective view of a mobile robot viewed from one direction according to an embodiment of the present disclosure, FIG. 2 is a perspective view of a driving module viewed from one direction according to an embodiment of the present disclosure, FIG. 3 is a perspective view of a driving module viewed from another direction according to an embodiment of the present disclosure, FIG. 4 is a plan view of a driving module viewed from above according to an embodiment of the present disclosure, and FIG. 5 is a side view of a driving module according to an embodiment of the present disclosure.

In FIGS. 1 to 5, +X refers to the front direction of the mobile robot 1 or the driving module 10, +Y refers to the left direction of the mobile robot 1 or the driving module 10, and +Z refers to the upper direction of the mobile robot 1 or the driving module 10.

Referring to FIGS. 1 to 5, the mobile robot 1 according to present embodiment includes a driving module 10 and a robot body 20.

The driving module 10 may include a frame 100 and a pair of wheel units 300.

The frame 100 supports the robot body 20. The pair of wheel units 300 may be coupled to the left and right areas of the frame 100, respectively, to tilt in the front and rear directions about a virtual axis line L extending in the left and right directions.

In more detail, the frame 100 may include a first support unit 110 and a second support unit 120. The first support unit 110 supports the wheel unit 300, and the second support unit 120 supports the robot body 20 with respect to the first support unit 110.

The first support unit 110 rotatably supports the wheel unit 300 about the virtual axis line L extending in the left and right directions. The pair of wheel units 300 is rotatably coupled to the left and right areas of the first support unit 110 about the virtual axis line L.

The first support 110 may include a rotating shaft 111 to which the pair of wheel units 300 are rotatably coupled.

For example, a pair of rotating shafts 111 may be provided. Each of the pair of rotating shafts 111 is disposed on the virtual axis line L and is disposed to be spaced apart from each other in the left and right directions.

Each of the pair of rotating shafts 111 rotatably supports the pair of wheel units 300. In this case, each wheel unit 300 may be rotatably coupled to each rotating shaft 111 via a bearing 210.

The pair of rotating shafts 111 may be coupled via a coupling support member 113. The pair of rotating shafts 111 may be coupled to the coupling support member 113 while aligned on the virtual axis line L. The coupling support member 113 may support the second support unit 120 to be described later. The coupling support member 113 constitutes a part of the first support unit 110.

The pair of rotating shafts 111 and the coupling support member 113 may be separately manufactured and coupled. At this time, the pair of rotating shafts 111 and the coupling support member 113 may be joined by various known methods such as welding, bolting, and pin coupling.

When the rotating shaft 111 constituting the first support 110 is provided as a pair, maintenance is easier and more economical than when there is only one rotating shaft because only the damaged rotating shaft needs to be repaired or replaced.

However, the pair of rotating shafts 111 and the coupling support member 113 may be manufactured as one piece in a casting manner.

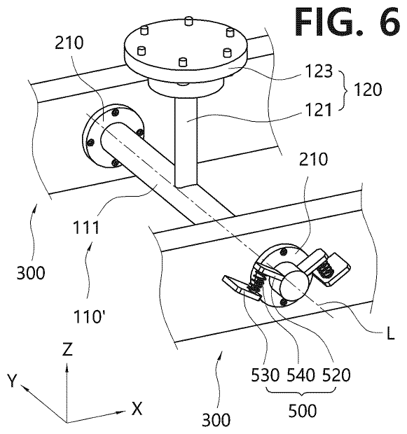

As another example, the rotating shaft 111 may extend in the left and right directions as a single member as shown in FIG. 6. For reference, FIG. 6 is a view illustrating a modified example of the first support unit shown in FIG. 2. Referring to FIG. 6, the rotating shaft 111 of the first support 110′ is disposed on the virtual axis line L.

The pair of wheel units 300 may be rotatably coupled to the left and right sides of the rotating shaft 111, which is a single member. In this case, each wheel unit 300 may be rotatably coupled to the rotating shaft 111 via the bearing 210. The second support unit 120 to be described later is supported on the rotating shaft 111.

When the rotating shaft 111 is provided as a single member as shown in FIG. 6, it is easier to install and handle the rotating shaft 111 than when there are several rotating shafts 111 as shown in FIG. 2.

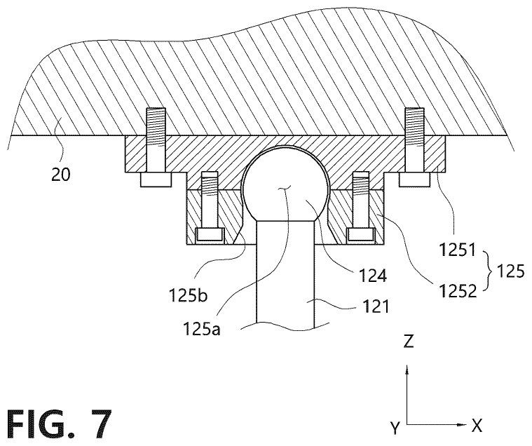

Referring to FIGS. 1 to 5, the second support unit 120 supports the robot body 20 with respect to the first support unit 110. FIG. 7 is a cross-sectional view taken along line A-A of FIG. 4.

For example, the second support unit 120 may include a support member 121 and a ball joint 123 as shown in FIG. 7.

Referring to FIGS. 1, 2 and 7, the support member 121 is supported on the first support and extends up and down. The support member 121 may have a rod shape.

The lower end of the support member 121 may be coupled to the first support unit 110. For example, the lower end of the support member 121 may be coupled to the coupling support member 113 of the first support unit 110. The support member 121 and the first support unit 110 may be joined using various known methods such as welding, bolting, and pin coupling.

The ball joint 123 is interposed between the support member 121 and the robot body 20. The ball joint 123 provides a degree of freedom of rotation between the support member 121 and the robot body 20 and couples the support member 121 and the robot body 20.

The ball joint 123 may include a ball 124 and a socket 125.

The ball 124 may be formed at an upper end of the support member 121. The socket 125 rotatably receives the ball 124 and is coupled to the robot body 20. The accommodating groove 125a for receiving the ball 124 is formed in the socket 125.

The socket 125 may include a first socket 1251, and a second socket 1252.

The first socket 1251 is coupled to the robot body 20. For example, the first socket 1251 may be bolted to the robot body 20. The first socket 1251 is provided with a part of the accommodating groove 125a that receives the ball 124.

The second socket 1252 is coupled to the first socket 1251 and rotatably supports the ball 124. The second socket 1252 is provided with a part of the accommodating groove 125a that receives the ball 124.

The robot body 20 coupled to the support member 121 by the ball joint 123 may be supported by the support member 121 with a degree of freedom of rotation in multiple directions. In this case, the driving module 10 may rotate in multiple directions with respect to the robot body 20 while being coupled to the robot body 20.

An inclined surface 125b may be formed on an entrance side of the accommodating groove 125a of the second socket 1252. The inclined surface 125b prevents the robot body 20 from tilting at a predetermined angle or more relative to the support member 121 by being supported in contact with the side surface of the upper end of the support member 121 during the process of tilting the robot body 20 relative to the support member 121 by the ball joint 123.

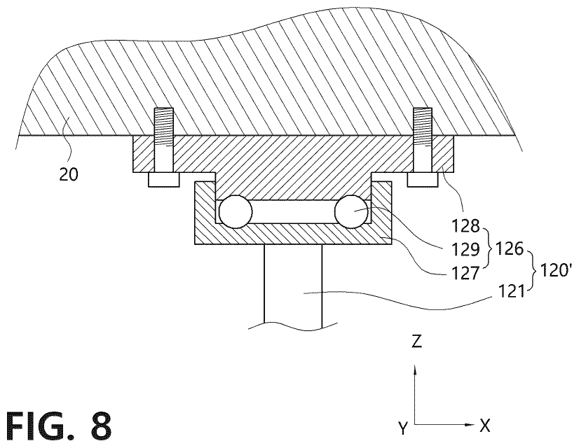

As another example, the second support unit 120′ may include a support member 121 and a thrust bearing 126 as shown in FIG. 8. For reference, FIG. 8 is a view illustrating a modified example of the second support unit shown in FIG. 7.

Referring to FIGS. 1, 2 and 8, the support member 121 is supported on the first support unit 110 and extends up and down. The support member 121 may have a rod shape.

The lower end of the support member 121 may be coupled to the first support unit 110. For example, the lower end of the support member 121 may be coupled to the coupling support member 113 of the first support unit 110. The support member 121 and the first support unit 110 may be joined using various known methods such as welding, bolting, and pin coupling.

The thrust bearing 126 is formed on the upper end of the support member 121 and couples the support member 121 and the robot body 20 while providing a degree of freedom of rotation between the support member 121 and the robot body 20.

The thrust bearing 126 supports the load in the extension direction of the support member 121 and induces relative rotation of the robot body 20 and the support member 121. The thrust bearing 126 may have a known shape and structure.

The thrust bearing 126 may include a fixing unit 127 and a rotating unit 128 that rotate relative to each other. The fixing unit 127 is configured to support the rotating unit 128 from below. A ball 129 or the like may be interposed between the fixing unit 127 and the rotating unit 128. The fixing unit 127 may be coupled to an upper end of the support member 121, and the rotating part 128 may be coupled to the robot body 20.

The robot body 20 coupled to the support member 121 by the thrust bearing 126 has a degree of freedom of rotation with respect to rotation about a central axis in the extension direction of the support member 121 and may be supported by the support member 121. In this case, the driving module 10 may rotate with respect to the robot body 20 while being coupled to the robot body 20.

Referring to FIGS. 1 to 5, the pair of wheel units 300 are rotatably supported about a virtual axis line L extending in the left and right directions on the frame 100. The wheel unit 300 may tilt in the front and rear directions about the virtual axis line L.

Each wheel unit 300 may include a base member 310, a front-wheel 330, a rear-wheel 340, and a driving unit 350.

The base member 310 is rotatably supported on the rotating shaft 111 of the frame 100 about the virtual axis line L.

A bearing 210 may be interposed between the base member 310 and the rotating shaft 111. The bearing 210 may be a radial bearing. In this case, the inner ring of the bearing 210 may be fixed to the rotating shaft 111, and the outer ring of the bearing 210 may be fixed to the base member 310. However, the bearing between the base member 310 and the rotating shaft 111 may be various types of known bearings.

The front-wheel 330 and the rear-wheel 340 may be rotatably coupled to the front and rear portions of the base member 310 based on the virtual axis line L, respectively, about axis lines L1, and L2 parallel to the virtual axis line L.

The front-wheel 330 may be coupled to one end of the front-wheel rotating shaft 331 to rotate integrally with the front-wheel rotating shaft 331. The front-wheel rotating shaft 331 may be rotatably supported on the base member 310.

In this case, a front-wheel bearing 220 may be interposed between the front-wheel rotating shaft 331 and the base member 310. The front-wheel bearing 220 may be a radial bearing. At this time, the inner ring of the front-wheel bearing 220 is fixed to the front-wheel rotating shaft 331 and the outer ring of the front-wheel bearing 220 is fixed to the base member 310.

The rear-wheel 340 may be coupled to one end of the rear-wheel rotating shaft 341 and rotate integrally with the rear-wheel rotating shaft 341. The rear-wheel rotating shaft 341 may be rotatably supported on the base member 310.

In this case, a rear-wheel bearing 230 may be interposed between the rear-wheel rotating shaft 341 and the base member 310. The rear-wheel bearing 230 may be a radial bearing. At this time, the inner ring of the rear-wheel bearing 230 is fixed to the rear-wheel rotating shaft 341, and the outer ring of the rear-wheel bearing 230 is fixed to the base member 310.

The front-wheel 330 and the rear-wheel 340 may have the same size as in FIGS. 2 to 4, but are not limited thereto and may have different sizes.

The driving unit 350 provides a rotational driving force to at least one of the front-wheel 330 and the rear-wheel 340.

In the present embodiment, the driving unit 350 may provide driving force to both the front-wheel 330 and the rear-wheel 340 to implement four-wheel driving. However, in another embodiments, the driving unit 350 may transmit driving force to either the front-wheel 330 or the rear-wheel 340.

According to the present embodiment, the driving unit 350 includes the driving motor 351 and the power transmission unit 352.

The driving motor 351 generates the rotational driving force. The driving motor 351 is supported on the base member 310.

The power transmission unit 352 transmits the rotational driving force generated by the driving motor 351 to at least one of the front-wheel 330 and the rear-wheel 340. In the present embodiment, the power transmission unit 352 transmits the rotational driving force to both the front-wheel 330 and the rear-wheel 340.

The power transmission unit 352 may include a driving pulley 3521, a driven pulley 3522, a main belt 3523, a first pulley 3524, a second pulley 3525, and a sub-belt 3526.

The driving pulley 3521 is coupled to the driving motor 351. When the driving motor 351 operates, the driving pulley 3521 rotates. The driving pulley 3521 may rotate about an axis line L3 parallel to the virtual axis line L.

The driven pulley 3522 is rotatably supported on the base member 310. At this time, the driven pulley 3522 has the same axis as the wheel selected from the front-wheel 330 and the rear-wheel 340. The wheel selected in the present embodiment is the front-wheel 330.

The driven pulley 3522 may be coupled to the front-wheel rotating shaft 331 coupled to the front-wheel 330. At this time, the driven pulley 3522 may rotate integrally with the front-wheel 330 and the front-wheel rotating shaft 331.

The main belt transmits power by connecting the driving pulley 3521 and the driven pulley 3522.

The first pulley 3524 is rotatably supported on the base member 310. At this time, the first pulley 3524 has the same axis line L1 as the front-wheel 330 and the driven pulley 3522. The first pulley 3524 may be coupled to the front-wheel rotating shaft 331 coupled to the front-wheel 330. At this time, the first pulley 3524 may rotate integrally with the driven pulley 3522, the front-wheel 330, and the front-wheel rotating shaft 331.

The second pulley 3525 is rotatably supported on the base member 310. At this time, the second pulley 3525 has the same axis as the unselected wheel among the front-wheel 330 and the rear-wheel 340. In the present embodiment, the unselected wheel is the rear-wheel 340.

The second pulley 3525 may be coupled to the rear-wheel rotating shaft 341 coupled to the rear-wheel 340. In this case, the second pulley 3525 may rotate integrally with the rear-wheel 340 and the rear-wheel rotating shaft 341.

The sub-belt 3526 connects the first pulley 3524 and the second pulley 3525 to transmit power.

In the driving unit 350, the rotational driving force generated by the driving motor 351 is simultaneously transmitted to the front-wheel 330 and the rear-wheel 340 through the power transmission unit 352, and the front-wheel 330 and the rear-wheel 340 rotate.

In the present embodiment, the driving pulley 3521, the driven pulley 3522, the main belt 3523, the first pulley 3524, the second pulley 3525, and the sub-belt 3526 may be provided in the form of a timing belt pulley.

In this case, the rotational driving force generated by the driving motor 351 may be efficiently transmitted to the front-wheel 330 and the rear-wheel 340 without slip between the pulleys 3521, 3522, 3524, and 3525, and the belts 3523, and 3526.

In the present embodiment, as shown in FIG. 4, the driving pulley 3521, the driven pulley 3522, the main belt 3523, the first pulley 3524, the second pulley 3525, and the sub-belt 3526 may be disposed on a side where the front-wheel 330 and the rear-wheel 340 are located about the base member 310.

In this case, the driving pulley 3521, the driven pulley 3522, the main belt 3523, the first pulley 3524, the second pulley 3525, and the sub-belt 3526 are exposed to the outside to facilitate maintenance.

In this case, the driving pulley 3521, the driven pulley 3522, the main belt 3523, the first pulley 3524, the second pulley 3525, and the sub-belt 3526 may be covered by a housing 355 separably coupled to the base member 310. For reference, the housing 355 is illustrated only in FIG. 4.

The housing 355 may be coupled to the base member 310 in a bolt coupling manner.

The housing 355 coupled to the base member 310 may prevent the driving pulley 3521, the driven pulley 3522, the main belt 3523, the first pulley 3524, the second pulley 3525, and the sub-belt 3526 from being exposed to the outside and being damaged.

In addition, the housing 355 may be separated from the base member 310 for repair and replacement of the driving pulley 3521, the driven pulley 3522, the main belt 3523, the first pulley 3524, the second pulley 3525, and the sub-belt 3526.

Meanwhile, the power transmission unit transmits the rotational driving force generated by the driving motor to both the front-wheel and the rear-wheel, and the driving module may implement four-wheel driving.

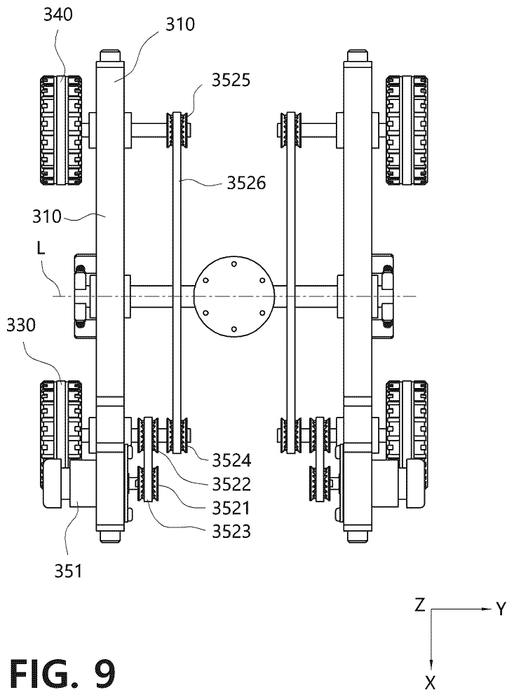

In another embodiment, as shown in FIG. 9, the driving pulley 3521, the driven pulley 3522, the main belt 3523, the first pulley 3524, the second pulley 3525, and the sub-belt 3526 may be disposed on an opposite side of the side where the front-wheel 330 and the rear-wheel 340 are located about the base member 310. For reference, FIG. 9 is a view illustrating a modified example related to the arrangement of the power transmission unit shown in FIG. 4.

In this case, the driving pulley 3521, the driven pulley 3522, the main belt 3523, the first pulley 3524, the second pulley 3525, and the sub-belt 3526 are not exposed to the outside, so that the possibility of damage due to external force is lowered.

In the present embodiment, each wheel unit 300 faces a situation in which the heights of the front-wheel 330 and the rear-wheel 340 are changed in the process of passing through an uneven road surface. At this time, each wheel unit 300 performs a tilting operation with respect to the rotating shaft 111 of the frame 100, so that the front-wheel 330 and rear-wheel 340 may have a stable grip with the road surface. The pair of wheel units 300 may tilt with respect to the rotating shaft 111 of the frame 100, respectively, so that both the front-wheels 330 and the two rear-wheels 340 are supported to the road surface and may have more stable grip with the road surface.

In the present embodiment, the driving module 10 may move forward and backward or change direction by changing the rotation speed or rotation direction of the wheels 330 and 340 constituting each wheel unit 300.

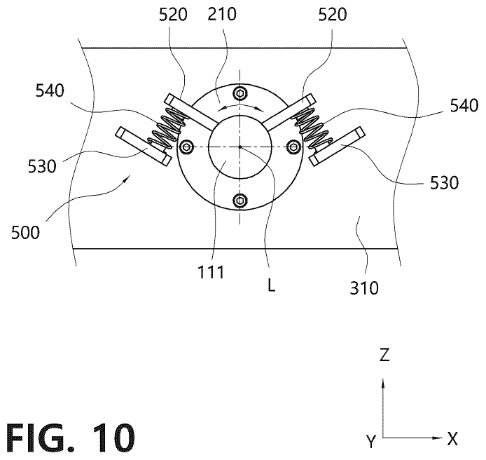

FIG. 10 is an enlarged view of a restoring force providing unit according to an embodiment of the present disclosure. Referring to FIGS. 1 to 4 and 10, the driving module 10 according to the present embodiment may further include a restoring force providing unit 500.

The restoring force providing unit 500 restores the wheel unit 300 to its original state before the tilting operation when the wheel unit 300 tilts with respect to the frame 100 about the virtual axis line L.

The restoring power providing unit 500 is provided as a pair corresponding to the number of wheel units 300.

In the present embodiment, the restoring force providing unit 500 may include a first plate 520, a second plate 530, and an elastic body 540.

The first plate 520 may be coupled to the rotating shaft 111 and may extend radially from the rotating shaft 111. The first plate 520 and the rotating shaft 111 may be joined by a welding coupling or a bolt coupling.

The second plate 530 is coupled to the base member 310 to be spaced apart from the first plate 520 and disposed to face each other. The second plate 530 and the base member 310 may be joined by a welding coupling or a bolt coupling.

The elastic body 540 is interposed between the first plate 520 and the second plate 530 to provide an elastic force. Specifically, the elastic body 540 is interposed between the first plate 520 and the second plate 530 to provide the elastic force that restores the first plate to its original state before a gap change when there is the gap change between the first plate 520 and the second plate 530.

For example, when the gap between the first plate 520 and the second plate 530 is narrowed, the elastic body 540 provides the elastic force in a direction in which the gap between the first plate 520 and the second plate 530 is widened.

When the gap between the first plate 520 and the second plate 530 is widened, the elastic body 540 provides the elastic force in a direction in which the gap between the first plate 520 and the second plate 530 is narrowed.

When one of the front-wheel 330 or the rear-wheel 340 relatively ascends or descends due to uneven ground, the restoring force providing unit 500 may elastically relieve an impact due to the ascending or descending of the wheel unit 300 when the tilting operation of the wheel unit 300 occurs.

At this time, the restoring power providing unit 500 serves as a kind of buffer. Compared to a suspension mounted on a conventional vehicle and robot, the present restoring force providing unit 500 is very effective because it is small in size and simple in structure and does not require a lot of installation space.

In addition, when the tilting operation of the wheel unit 300 occurs, the elastic force provided by the elastic body 540 may easily recover the wheel unit 300 to its original state before the tilting, thereby easily maintaining the balance of the driving module 10.

The elastic body 540 may have a coil spring shape, but is not limited thereto.

Both longitudinal sides of the elastic body 540 may be fixed and supported on one surface of the first plate 520 and one surface of the second plate 530 facing each other.

The first plate 520, the second plate 530, and the elastic body 540 are interlocked in one set and provide the elastic force to restore the wheel unit 300 to its original state during the tilting operation of the wheel unit 300.

A set consisting of the first plate 520, the second plate 530, and the elastic body 540 may be provided as a plural. The plurality of sets may be spaced apart from each other in a circumferential direction about the rotating shaft 111. The sets are shown as two in FIG. 10.

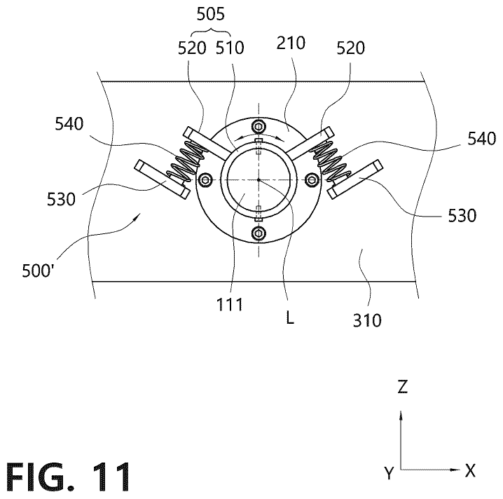

In another embodiment, as shown in FIG. 11, the restoring force providing unit 500 may include a hub structure 505, a second plate 530, and an elastic body 540. Referring to the drawing, FIG. 11 is a view illustrating a modified example of the restoring force providing unit shown in FIG. 10.

The hub structure 505 includes a hub 510 and a first plate 520. The hub 510 has a hollow shape and is coupled to the rotating shaft 111. The hub 510 and the rotating shaft 111 may be joined by a bolt coupling or a pin coupling.

The first plate 520 extends radially from the hub 510. A plurality of first plates 520 may be provided, and the plurality of first plates 520 may be spaced apart from each other from the hub 510 in the circumferential direction.

The second plate 530 is disposed to face the first plate 520 while being spaced apart from the first plate 520, and is coupled to the base member 310. The second plate 530 and the base member 310 may be joined by a welding coupling or a bolt coupling.

The number and arrangement of the second plate 530 may be determined corresponding to the number and arrangement of the first plate 520.

The elastic body 540 is interposed between the first plate 520 and the second plate 530 to provide an elastic force. The elastic body 540 may have a coil spring shape, but is not limited thereto. The number and arrangement of the elastic body 540 may be determined corresponding to the number and arrangement of the first plate 520 and the second plate 530.

Unlike the case in which the first plate 520 is directly coupled to the rotating shaft 111, the restoring force providing unit 500′ is easily installed by coupling the hub 510 to which the first plate 520 is coupled to the rotating shaft 111. In particular, when a plurality of the first plates 520 are used, ease of installation is further improved.

Referring to FIGS. 1 to 5, the robot body 20 is coupled to the driving module 10.

The robot body 20 may be mounted with a battery (not shown) to supply power to the driving motor 351 included in the driving module 10. Various electronic devices for controlling the driving module 20 and various electronic devices for performing a preset mission may be mounted on the robot body 20.

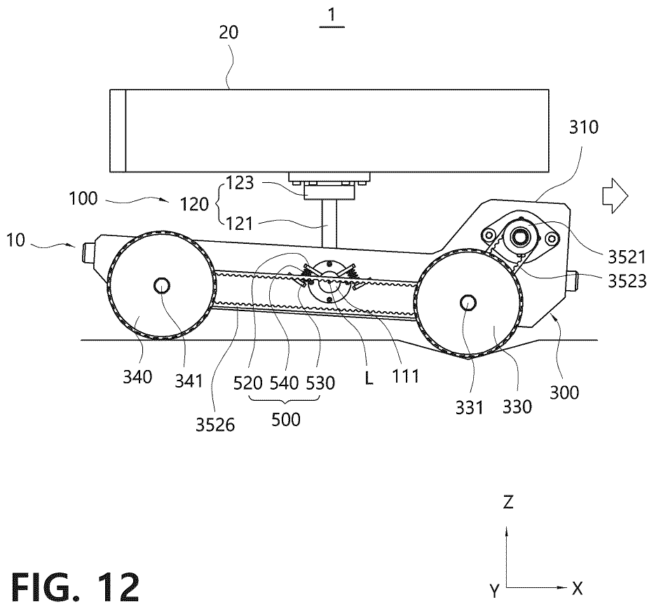

FIG. 12 is a view illustrating a state in which a mobile robot travels a bumpy road surface according to an embodiment of the present disclosure.

Referring to FIG. 12, in the process the mobile robot 1 combining the driving module 10 and the robot body 20 advances, the front-wheel 330 constituting the wheel unit 300 of the driving module 10 may be dropped into a concave portion of the road surface. In this case, the wheel unit 300 may tilt forward about the virtual axis line L. That is, the wheel unit 300 may rotate clockwise about the virtual axis line L as shown in FIG. 12.

In this way, the wheel unit 300 performs a tilting operation with respect to the rotating shaft 111 about the virtual axis line L depending on road surface conditions on which the drive module 10 is traveling, so that the drive module 10 is not restricted by the road surface conditions and may be traveling with a sense of balance by being supported at four points on the road surface, that is, by the two front-wheels 330 and two rear-wheels 340 included in the pair of wheel units 300.

And, as shown in FIG. 12, the restoring force providing unit 500 restores the wheel unit 300 to its original state before the tilting operation when the wheel unit 300 tilts with respect to the rotating shaft about the virtual axis line L, so that the impact due to the tilting operation may be alleviated with elasticity, and the wheel unit 300 may be easily restored to its original tilting state, making it easy to maintain the balance of the driving module 10.

According to the above configuration, according to one aspect of the present disclosure, the wheel unit tilts with respect to the rotating shaft of frame about the virtual axis line according to the road surface conditions, so that the drive module is not restricted by the road surface conditions and may be traveling with a sense of balance by being supported at four points on the road surface, that is, by the two front-wheels and two rear-wheels included in the pair of wheel parts.

Furthermore, the restoring force providing unit restores the wheel unit to its original state before the tilting operation when the wheel unit performs the tilting operation with respect to the rotating shaft of frame about the virtual axis line, so that the impact due to the tilting motion may be alleviated with elasticity, and the wheel unit may be easily restored to its original tilting state, making it easy to maintain the balance of the drive module.

It should be understood that the effects of the present disclosure are not limited to the above-described effects and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A driving module comprising:
a frame supporting a robot body; and
a pair of wheel units respectively coupled to left and right areas of the frame to tilt in front and rear directions about a virtual axis line extending in left and right directions,
wherein each of the pair of wheel units comprise:
a base member rotatably coupled to the frame about the virtual axis line;
a front-wheel rotatably coupled to the front portion of the base member based on the virtual axis line about an axis line parallel to the virtual axis line;
a rear-wheel rotatably coupled to the rear portion of the base member based on the virtual axis line about an axis line parallel to the virtual axis line; and
a driving unit providing a rotational driving force to at least one of the front-wheel and the rear-wheel.

2. The driving module of claim 1, wherein the frame comprises:
a first support unit to which the pair of wheel units is rotatably coupled about the virtual axis line; and
a second support unit supporting the robot body with respect to the first support unit.

3. The driving module of claim 2, wherein the first support unit comprises a rotating shaft disposed on the virtual axis line and to which the pair of wheel units are rotatably coupled.

4. The driving module of claim 3, wherein the rotating shaft is provided as a single member extending in the left and right directions.

5. The driving module of claim 3, wherein a pair of rotating shafts is provided, the pair of rotating shafts are disposed to be spaced apart from each other in left and right directions, the pair of wheel units are rotatably coupled to the pair of rotating shafts, and
wherein the first support unit further comprises a coupling support member that couples the pair of rotating shafts in an aligned state on the virtual axis line.

6. The driving module of claim 2, wherein the second support unit comprises:
a support member extending up and down and supported by the first support unit; and
a ball joint interposed between the support member and the robot body and providing a degree of freedom of rotation between the support member and the robot body, and coupling the support member and the robot body.

7. The driving module of claim 6, wherein the ball joint comprises:
a ball formed at an upper end of the support member; and
a socket having an accommodating groove for receiving the ball, and coupled to the robot body.

8. The driving module of claim 7, wherein an inclined surface is formed on the entrance side of the accommodating groove.

9. The driving module of claim 2, wherein the second support unit comprises:
a support member supported on the first support unit and extending up and down; and
a thrust bearing interposed between the support member and the robot body and providing a degree of freedom of rotation between the support member and the robot body and coupling the support member and the robot body.

10. The driving module of claim 1, further comprising:
a pair of restoring force providing unit providing a restoring force to restore each of the pair of wheel units to its original state before the tilting operation when each of the pair of wheel units tilts with respect to the frame about the virtual axis line.

11. The driving module of claim 10, wherein the frame comprises a rotating shaft to which the pair of wheels are rotatably coupled about the virtual axis line, and
wherein each of the pair of restoring force providing units comprise:
a first plate coupled to the rotating shaft and extending radially from the rotating shaft;
a second plate coupled to the base member to be spaced apart from the first plate to face the first plate; and
a resilient body interposed between the first plate and the second plate and providing an elastic force to restore the first plate to its original state before a gap change when there is the gap change between the first plate and the second plate.

12. The driving module according to claim 10, wherein the frame comprises a rotating shaft to which the pair of wheels are rotatably coupled about the virtual axis line, and
wherein each of the pair of restoring force providing units each comprise:
a hub structure comprising a hub having a hollow shape and coupled to the rotating shaft, and a first plate having one end coupled to the hub and extending radially from the hub;
a second plate coupled to the base member to be spaced apart from the first plate while facing the first plate; and
a resilient body interposed between the first plate and the second plate and providing an elastic force to restore the first plate to its original state before a gap change when there is the gap change between the first plate and the second plate.

13. The driving module according to claim 1, wherein the driving unit comprises:
a driving motor supported on the base member; and
a power transmission unit that transmits the rotational driving force generated by the driving motor to at least one of the front-wheel and the rear-wheel.

14. The driving module according to claim 13, wherein the power transmission unit comprises:
a driving pulley coupled to the driving motor and rotating about an axis line parallel to the virtual axis line;
a driven pulley having the same axis line as a selected wheel among the front-wheel and the rear-wheel, and rotatably supported on the base member;
a main belt that connects the driving pulley and the driven pulley to transmit power;
a first pulley having the same axis as the selected wheel and the driven pulley, and rotatably supported on the base member;
a second pulley having the same axis as an unselected wheel among the front-wheel and the rear-wheel, and rotatably supported on the base member; and
a sub-belt that connects the first pulley and the second pulley to transmit power,
wherein the selected wheel, the driven pulley, and the first pulley are coupled to the rotating shaft of the selected wheel, which is rotatably supported on the base member, and
the unselected wheel and the second pulley are coupled to the rotating shaft of the unselected wheel, which is rotatably supported on the base member.

15. The driving module according to claim 14, wherein the driving pulley, the driven pulley, the main belt, the first pulley, the second pulley, and the sub-belt are provided in the form of a timing belt pulley.

16. The driving module according to claim 14, wherein the driving pulley, the driven pulley, the main belt, the first pulley, the second pulley, and the sub-belt are disposed on a side where the front-wheel and the rear-wheel are located about the base member.

17. The driving module according to claim 16, wherein the driving pulley, the driven pulley, the main belt, the first pulley, the second pulley, and the sub-belt are covered by a housing coupled to the base member.

18. The driving module according to claim 14, wherein the driving pulley, the driven pulley, the main belt, the first pulley, the second pulley, and the sub belt are disposed on an opposite side of the side where the front-wheel and the rear-wheel are located about the base member.

19. The driving module according to claim 13, wherein the power transmission unit transmits the rotational driving force generated by the driving motor to both the front-wheel and the rear-wheel, and
wherein the driving module implements four-wheel drive.

20. A mobile robot comprising:
a driving module according to claim 1; and
the robot body supported on the frame of the driving module.
